(19) United States
(12) Patent Application Publication
(10) Pub. No.: US 2011/0063579 A1
(43) Pub. Date: Mar. 17, 2011

(54) PROJECTING SYSTEM

(76) Inventor: Ming-Yu Wang, Taichung County (TW)

(21) Appl. No.: 12/557,537

(22) Filed: Sep. 11, 2009

(51) Int. Cl. G03B 21/14

(52) U.S. Cl. 353/20

(57) ABSTRACT

A projecting system is disclosed. The projecting system includes: a light source; a lens group disposed on the exit of the light source, wherein the lens group comprises a polarizing beam splitter; and at least one rectangular prism disposed on one side of the prism group and between the polarizing beam splitter and the light source.

### BACKGROUND OF THE INVENTION

1. Field of the Invention

The invention relates to a projecting system and more particularly to a projecting system of having a prism between the polarizing beam splitter and the light source.

2. Description of the Prior Art

Projectors are conventionally used in conference briefings in which a host projects data or graphics onto a screen for familiarizing attendants with a presentation. With the rapid development of technology, projectors are now widely used in other applications. With high-power hi-fi equipment, large-capacity digital video discs (DVDs), and the large images that can be generated by projectors, it is now possible to reconstruct at home visual and audio effects similar to those provided in a movie theater.

However, consumer projectors sold on market today typically have the disadvantage of insufficient brightness. For instance, after light is projected from a light source in a projecting system to a light-entering plane of a lens groups, the light is redefined through a polarizing beam splitter (PBS), reflected by a LCoS panel, and directed from a light-exit plane of the lens group to a projecting lens group. The projecting lens group then projects the corresponding image onto a screen. It should be noted that light projected from the light source onto the light-entering plane of the lens group is typically circular. However, as the light-entering plane of the lens group used for collecting light is built with a rectangular design, the mismatch between the light-entering plane of the lens group and the light produced from the light source often results in reduction of light and lowers the overall brightness of the display panel substantially.

### SUMMARY OF THE INVENTION

It is an objective of the present invention to provide a projecting system for solving the disadvantage of having insufficient brightness in current projecting system.

According to a preferred embodiment of the present invention, a projecting system is disclosed. The projecting system includes: a light source; a lens group disposed on the exit of the light source, wherein the lens group comprises a polarizing beam splitter; and at least one rectangular prism disposed on one side of the prism group and between the polarizing beam splitter and the light source.

According to another aspect of the present invention, a projecting system is disclosed. The projecting system includes: a light source; a lens group disposed on the exit of the light source, wherein the lens group comprises a polarizing beam splitter; and a plurality of segmented prism disposed on one side of the lens group and between the polarizing beam splitter and the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of a projecting system according to a preferred embodiment of the present invention.

FIGS. 2-4 illustrate enlarged views of a prism of FIG. 1 according to different embodiments of the present invention.

FIG. 5 illustrates a perspective view of a projecting system according to another embodiment of the present invention.

FIG. 6 illustrates an enlarged view of the segmented prism shown in FIG. 5.

### DETAILED DESCRIPTION

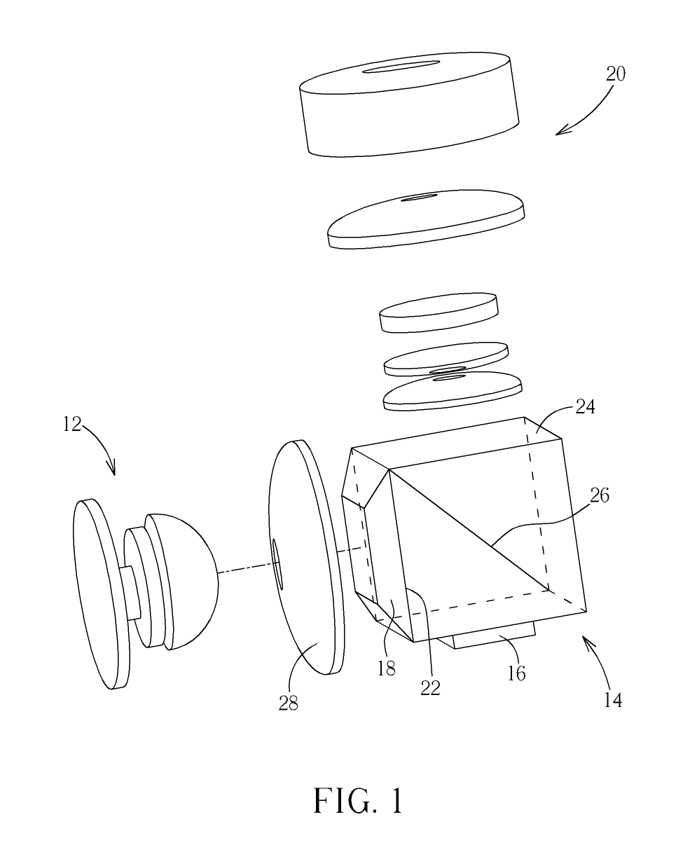

Referring to FIG. 1, FIG. 1 illustrates a perspective view of a projecting system according to a preferred embodiment of the present invention. Preferably, the projecting system could be constructed to project three-dimensional pictures or regular two-dimensional pictures, and an embodiment for projecting two-dimensional pictures is explained below. As shown in FIG. 1, the projecting system includes a light source 12, a lens 28 for collecting light, a lens group 14, a liquid crystal on silicon (LCoS) panel 16, a prism 18 disposed on a light-entering plane 22 and a projecting lens group 20 disposed on a light-exit plane 24 of the lens group 14.

The light source 12 provides light required by the projecting system, in which the light source 12 could be composed of various light emitting elements including light emitting diodes (LEDs) or high intensity light bulbs. The lens 28 is situated between the light source 12 and the lens group 14, and is preferably used to focus the light emitted from the light source 12 onto the light-entering plane 22 of the lens group 14. Despite the lens 28 of this embodiment is composed of one single lens, the lens 28 could also be a composite lens structure with a plurality of lenses having focusing mechanisms, which is also within the scope of the present invention.

The lens group 14 is situated relative to the exit of the light source 12, in which the lens group 14 could include a polarizing beam splitter (PBS) 26 coating to redefine the unpolarized light beam projected from the light source 12 into P-polarizing beam and S-polarizing beam. The defined P-polarizing beam and the S-polarizing beam are reflected from the LCoS panel 16 to the projecting lens group 20. The projecting lens group 20 is composed of a plurality of lenses and situated relative to the exit-plane 24 of the lens group 14 and opposite to the LCoS panel 16. Light reflected from the LCoS panel 16 are directed through the projecting lens group 20 to a screen (not shown) to display a corresponding image. In this embodiment, the light-entering plane 22 of the lens group 14 is rectangular, hence the prism 18 is preferably rectangular or square. Nevertheless, the shape of the prism 18 could also be adjusted according to the shape of the light-entering plane 22 of the lens group 14, which is within the scope of the present invention. The prism 18 is disposed between the polarizing beam splitter 26 of the lens group 14 and the light source 12, and is preferably adhered onto the light-entering plane 22 of the lens group 14. As light entering the lens group 14 first passes through the prism 18, the prism 18 is preferably used to adjust and gather the light entering the lens group 14, such that the LCoS panel 16 could receive much stronger light.

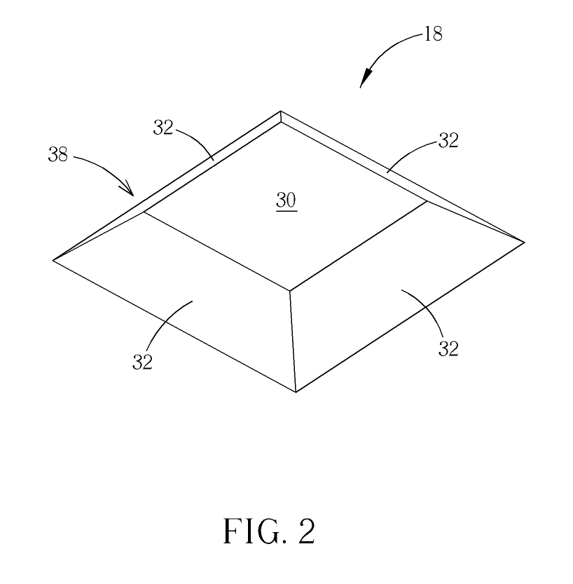

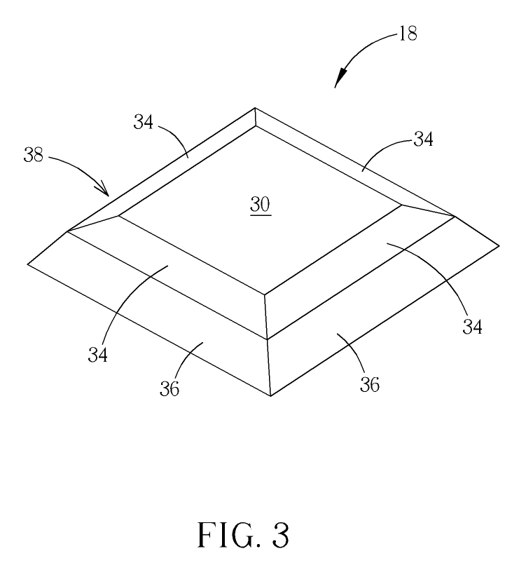

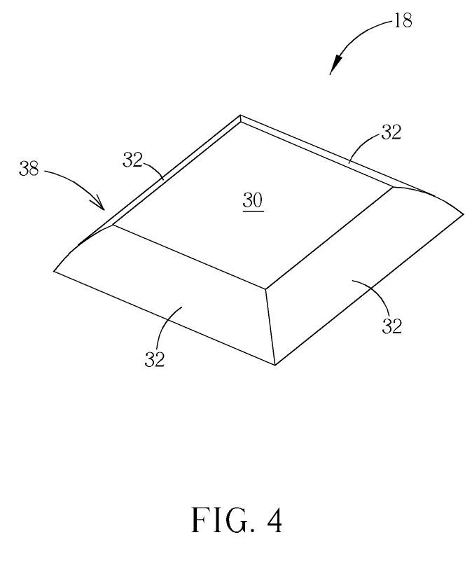

Referring to FIGS. 2-4, FIGS. 2-4 illustrate enlarged views of the prism 18 according to different embodiments of the present invention. As shown in the figures, the prism 18 is fabricated according to the light-entering plane 22 of the lens group 14 with a central region 30 and a peripheral region 38. The peripheral region 38 of the prism 18 includes four sides, in which each sides has at least one inclined surface 32, and the inclined surface 32 could have equal or different slopes. As shown in FIG. 2, the peripheral region 38 of the prism 18 includes a total of four inclined surfaces 32 surrounding the rectangular central region 30, in which each of the inclined surfaces 32 is a flat surface. However, one or more inclined surfaces 34/36 could be formed in the peripheral region 38, as shown in FIG. 3, and the inclined surfaces 34/36 could have same or different slopes therebetween. In addition to flat surfaces, the surface 32 of the peripheral region 38 of the prism 18 is fabricated with an arced profile, as shown in FIG. 4. Overall, the peripheral region 38 of the aforementioned embodiments could be used to gather light emitted from the light source 12 to the lens group 14, and the slope of the flat surface and degree of arced profile of the peripheral region 38 could all be adjusted according to the demand of the product.

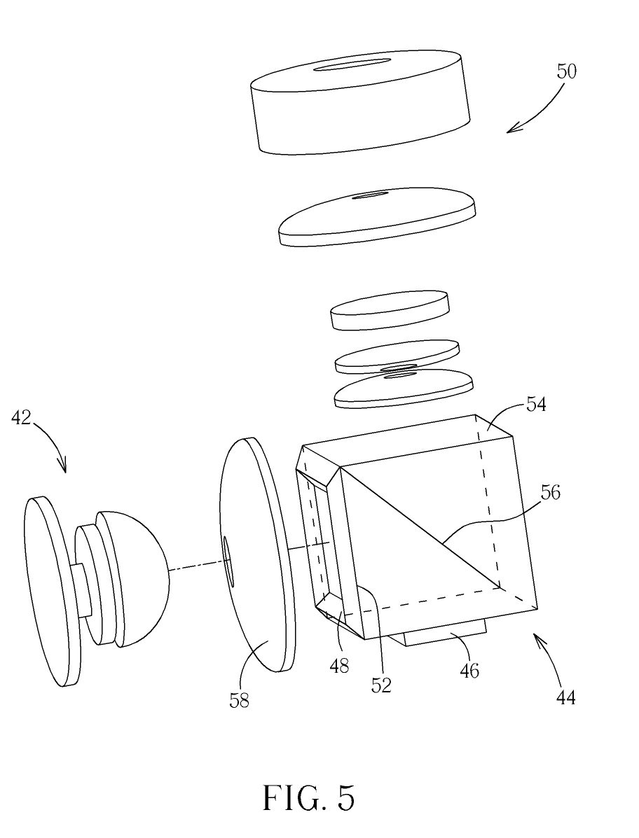

Referring to FIG. 5, FIG. 5 illustrates a perspective view of a projecting system according to another embodiment of the present invention. The projecting system of this embodiment could also be constructed to project three-dimensional pictures or regular two-dimensional pictures, and an embodiment for projecting two-dimensional pictures is explained below. As shown in FIG. 5, the projecting system includes a light source 42, a lens 58 for collecting light, a lens group 44, a liquid crystal on silicon (LCoS) panel 46, a plurality of segmented prisms 48 disposed on a light-entering plane 52 and a projecting lens group 50 disposed on a light-exit plane 54 of the lens group 44.

Similar to the aforementioned embodiment, the light source 42 provides light required by the projecting system, in which the light source 42 could be composed of various light emitting elements including light emitting diodes (LEDs) or high intensity light bulbs. The lens 58 is situated between the light source 42 and the lens group 44, and is preferably used to focus the light emitted from the light source 42 onto the light-entering plane 52 of the lens group 44. Despite the lens 58 of this embodiment is composed of one single lens, the lens 58 could also be a composite lens structure with a plurality of lenses having focusing mechanisms, which is also within the scope of the present invention.

The lens group 44 is situated relative to the exit of the light source 42, in which the lens group 44 could include a polarizing beam splitter (PBS) 56 coating to redefine the unpolarized light beam projected from the light source 42 into P-polarizing beam and S-polarizing beam. The defined P-polarizing beam and the S-polarizing beam are reflected from the LCoS panel 46 to the projecting lens group 50. The projecting lens group 50 is composed of a plurality of lenses and situated relative to the exit-plane 54 of the lens group 44 and opposite to the LCoS panel 46. Light reflected from the LCoS panel 46 are directed through the projecting lens group 50 to a screen (not shown) to display a corresponding image.

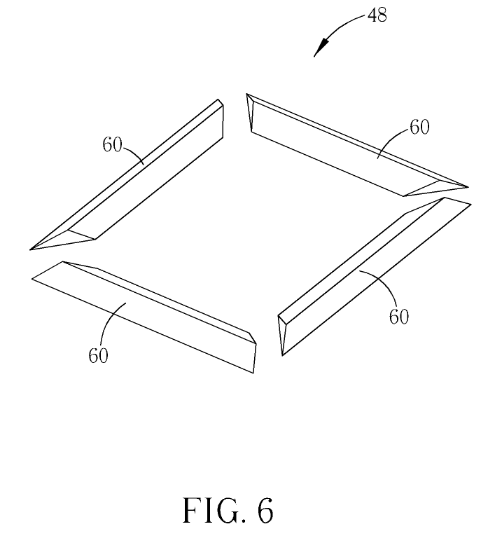

In contrast to the aforementioned rectangular prism 18, a plurality of segmented prisms 48 is disposed on the light-entering plane 52 of the lens group 44, in which the segmented prisms 48 are preferably composed of a frame consisting of four bar-shaped prisms. Referring to FIG. 6, FIG. 6 illustrates an enlarged view of the segmented prism 48 shown in FIG. 5. As shown in FIG. 6, the segmented prisms 48 include at least one inclined surface 60, in which the inclined surfaces 60 could have equal or different slopes therebetween. Similar to the aforementioned embodiment of using peripheral region 38 of the lens 18 for adjusting and gathering light entering the PBS, the inclined surface 60 of this embodiment is preferably used for gather light entering the lens group 44, such that more lights are collected and gathered on the lens group 44 and the LCoS panel 46 for displaying much better images.

Despite the above embodiments are applied to a projecting system having one single LCoS panel as a base for projecting 2D images, the present invention could also apply the above embodiments to a projecting system with two LCoS panels for producing 3D images, which is also within the scope of the present invention.

Those skilled in the art will readily observe that numerous modifications and alterations of the device and method may be made while retaining the teachings of the invention.

What is claimed is:

1. A projecting system, comprising:
a light source;
a lens group disposed on the exit of the light source, wherein the lens group comprises a polarizing beam splitter; and
at least one rectangular prism disposed on one side of the prism group and between the polarizing beam splitter and the light source.

2. The projecting system of claim 1, wherein the rectangular prism comprises a central region and a peripheral region.

3. The projecting system of claim 2, wherein the peripheral region comprises four sides, wherein each side comprises a first inclined surface with equal or different slope.

4. The projecting system of claim 3, wherein one of the four sides comprises at least one inclined surface.

5. The projecting system of claim 1, wherein the light source comprises light emitting diode.

6. The projecting system of claim 1, further comprising a projecting lens group disposed on a light-exit plane of the lens group.

7. The projecting system of claim 6, further comprising a LCoS panel disposed on a side opposite to the light-exit plane of the lens group.

8. A projecting system, comprising:
a light source;
a lens group disposed on the exit of the light source, wherein the lens group comprises a polarizing beam splitter; and
a plurality of segmented prism disposed on one side of the lens group and between the polarizing beam splitter and the light source.

9. The projecting system of claim 8, wherein the segmented prism comprises a frame consisting of four bar shaped prisms.

10. The projecting system of claim 8, wherein the segmented prisms comprise a first inclined surface with equal or different slope therebetween.

11. The projecting system of claim 10, wherein the segmented prisms comprise at least one second inclined surface.

12. The projecting system of claim 8, wherein the light source comprises light emitting diode.

13. The projecting system of claim 8, further comprising a projecting lens group disposed on the light-exit plane of the lens group.

14. The projecting system of claim 13, further comprising a LCoS panel disposed on a side opposite to the light-exit plane of the lens group.
